(19) United States
(12) Patent Application Publication
(10) Pub. No.: US 2023/0219397 A1
(43) Pub. Date: Jul. 13, 2023

(54) VEHICLE CONTROL SYSTEM

(71) Applicant: TOYOTA JIDOSHA KABUSHIKI KAISHA, Aichi-ken (JP)

(72) Inventors: Hirotaka SASAKI, Nagoya-shi (JP); Takahisa KANEKO, Toyota-shi (JP); Masahiro NISHIYAMA, Toyota-shi (JP); Kenji TSUKAGISHI, Toyota-shi (JP)

(21) Appl. No.: 18/146,460

(22) Filed: Dec. 27, 2022

(30) Foreign Application Priority Data
Jan. 12, 2022 (JP) 2022-002779

(51) Int. Cl. B60H 1/00; B60H 1/32

(52) U.S. Cl. CPC B60H 1/00878; B60H 1/3208

(57) ABSTRACT

A vehicle control system is provided, in which an engine ECU starts fuel cut control when deceleration is requested, and an air conditioner ECU operates a compressor to accumulate the cold during operation when the fuel cut control is performed by an engine controller, and deactivates the compressor in a case where an evaporator temperature matches or falls below a predetermined value of a compressor deactivation permissible temperature when a condition of terminating the fuel cut control is satisfied. The engine ECU extends the fuel cut control in a case where the compressor is deactivated when the condition of terminating the fuel cut control is satisfied. The air conditioner ECU includes a compressor deactivation permissible temperature changing unit configured to raise the compressor deactivation permissible temperature from the predetermined value when an estimated air conditioning load is low.

### CROSS REFERENCE TO RELATED APPLICATION

This application claims priority to Japanese Patent Application No. 2022-002779 filed on Jan. 12, 2022, which is incorporated herein by reference in its entirety including the specification, claims, drawings, and abstract.

### TECHNICAL FIELD

The present disclosure relates to a vehicle control system in which a compressor is operated to cool an evaporator for accumulating the cold therein while fuel cut control is performed, and the compressor is deactivated in a case where a temperature of the evaporator matches or falls below a predetermined temperature when a condition of terminating the fuel cut control is satisfied.

### BACKGROUND

A vehicle air conditioner described in JP 2010-234837 A includes a compressor which is driven by an engine for travelling. Further, the engine of JP 2010-234837 A is operated under fuel cut control to stop fuel supply to the engine during deceleration of the vehicle.

In vehicle air conditioners, such as the above-described vehicle air conditioner, the compressor is operated to cool an evaporator for accumulating the cold therein while the fuel cut control is engaged, and the compressor is deactivated when the temperature of an evaporator matches or falls below a predetermined temperature at the time of terminating the fuel cut control.

However, when air conditioning loads are low in the vehicle air conditioners, in some cases, the compressor may not necessarily be operated even though the temperature of the evaporator is higher than the predetermined temperature. In such a case, it may be desirable that the compressor be deactivated and the fuel cut control be extended, to thereby improve fuel efficiency.

Given these circumstances, it is an object of the present disclosure to provide a vehicle control system capable of increasing occurrences of a situation where fuel cut control can be extended. (a vehicle control system capable of allowing more situations where fuel cut control can be extended)

### SUMMARY

A vehicle control system according to the present disclosure includes an engine controller which performs fuel cut control for stopping fuel supply to an engine, and an air conditioner controller which controls an air conditioner, that is equipped with a compressor which is driven by a rotational driving force of the engine, wherein the engine controller is configured to start the fuel cut control in response to a request for deceleration, the air conditioner controller is configured to operate the compressor for accumulating the cold when the fuel cut control is being performed by the engine controller, and deactivate the compressor in a case where a temperature of an evaporator matches or falls below a predetermined value of a compressor deactivation permissible temperature when a condition of terminating the fuel cut control is satisfied, and the engine controller is further configured to extend the fuel cut control in a case where the compressor is deactivated when the condition of terminating the fuel cut control is satisfied. In the vehicle control system, the air conditioner controller includes a compressor deactivation permissible temperature changing unit configured to set a value greater than the predetermined value as the compressor deactivation permissible temperature when an estimated air conditioning load is low.

With the above-described configuration, it becomes possible to increase the occurrence of situations where the fuel cut control is extended, which can, in turn, improve fuel efficiency of the vehicle.

In the vehicle control system according to an aspect of the present disclosure, the air conditioner controller may include an air conditioning load estimator which is configured to estimate an air conditioning load based on at least one of an outside air temperature, a target discharge temperature, a vehicle interior temperature, and an air discharge volume.

In the vehicle control system according to another aspect of the present disclosure, the compressor may be of a variable capacity type, and the air conditioner controller may be further configured to maximize a capacity of the compressor when the fuel cut operation is being performed by the engine controller, to thereby operate the compressor at a maximum output.

When configured as described above, energy obtained from a rotational driving force of the engine during operation of the fuel cut control can be utilized to a maximum degree in the air conditioner for accumulating the cold.

In the vehicle control system according to this disclosure, occurrences of situations where the fuel cut control is extended can be increased, which can, in turn, improve the fuel efficiency of the vehicle.

### BRIEF DESCRIPTION OF DRAWINGS

Embodiments of the present disclosure will be described based on the following figures, wherein:

FIG. 1 is a schematic diagram showing a vehicle incorporating a vehicle control system in an example according to an embodiment;

FIG. 2 is a schematic diagram showing the vehicle control system in the example according the embodiment;

FIG. 3 is a block diagram showing a configuration of the vehicle control system in the example according to the embodiment;

FIG. 4 is a graph representing a relationship between a compressor deactivation permissible temperature and an outside air temperature;

FIG. 5 is a graph representing a relationship between the compressor deactivation permissible temperature and a target discharge temperature;

FIG. 6 is a flowchart showing a flow of actions of the vehicle control system; and

FIG. 7 is a timing chart showing changes in a vehicle speed, status of a fuel cut control flag, changes in compressor output, and changes in evaporator temperature.

### DESCRIPTION OF EMBODIMENTS

Hereinafter, an example according to an embodiment of the present disclosure will be explained. In the following description, specific shapes, materials, directions, numerical values, and other elements are presented by way of illustration to facilitate understanding of this disclosure, and may be changed as appropriate depending on applications, purposes, and specifications, for example.

### Vehicle

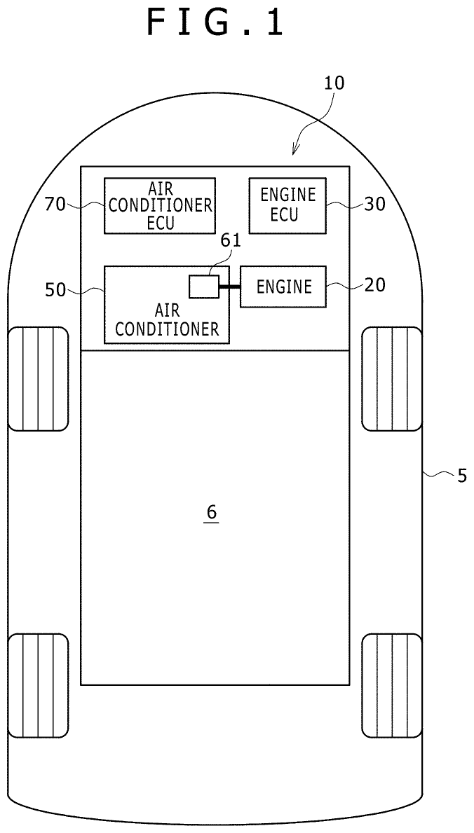

A vehicle 5 equipped with a vehicle control system 10 which is an example according to an embodiment will be explained with reference to FIG. 1.

The vehicle 5 includes the vehicle control system 10. The vehicle 5 is an engine vehicle having an engine 20 for travelling.

### Vehicle Control System

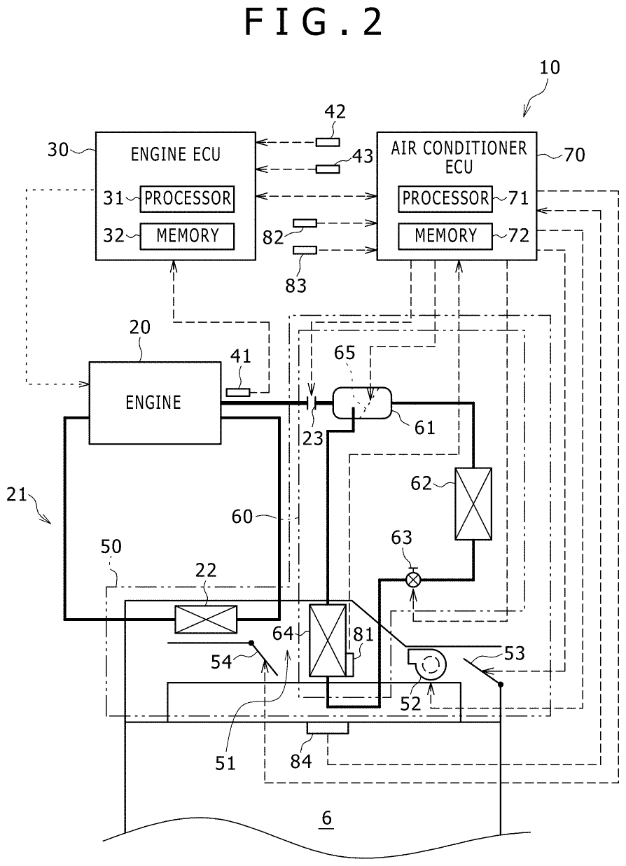

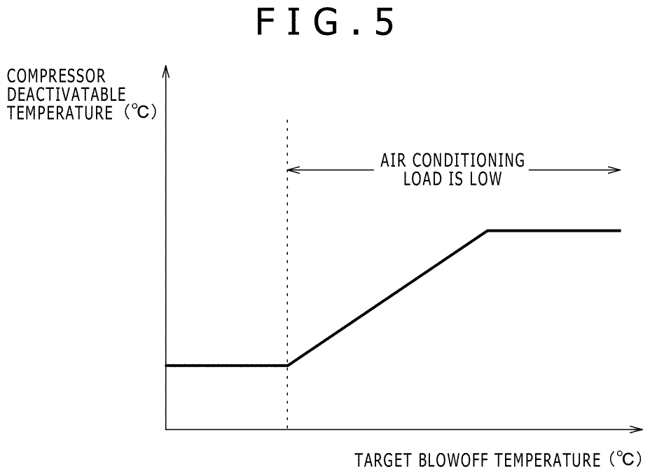

The vehicle control system 10 in the example according to the embodiment will explained with reference to FIGS. 2 to 5.

The vehicle control system 10 includes an engine ECU 30 which performs fuel cut control (hereinafter, abbreviated as “F/C control”) to stop fuel supply to the engine 20, and an air conditioner ECU 70 which controls an air conditioner 50 configured to condition air within a vehicle interior 6, the air conditioner 50 including a compressor 61 which is actuated by a rotational driving force of the engine 20.

In the vehicle control system 10, the fuel efficiency of the vehicle 5 can be improved by allowing more situations where the F/C control can be extended, which will be explained in detail below.

### Engine

As shown in FIG. 2, the engine 20 is cooled by an engine cooling circuit 21 and is controlled by the engine ECU 30. Further, the engine 20 is configured to drive a compressor 61 that is inserted in a refrigeration cycle circuit 60 of the air conditioner 50, which will be explained below, by means of a clutch 23. The engine cooling circuit 21 includes a heater core 22 installed in an air passage 51 of the air conditioner 50. The heater core 22 uses exhaust heat from the engine 20 to heat air flowing through the air passage 51.

### Engine ECU

As shown in FIG. 2, the engine ECU 30 includes a processor 31 which incorporates a CPU, and a memory 32 which stores a control program and control data, for example. The memory 32 may be implemented, for example, by a RAM, a ROM, a flash memory, or the like. The processor 31 is operated in accordance with the control program stored in the memory 32 to control the engine 20.

In addition, the engine ECU 30 is connected to an engine rpm sensor 41 which detects the rotational speed (rpm) of the engine 20, a vehicle speed sensor 42 which detects a speed of the vehicle 5, and an accelerator opening sensor 43 which detects an accelerator opening. The engine ECU 30 is also connected to the air conditioner ECU 70 which will be described further below.

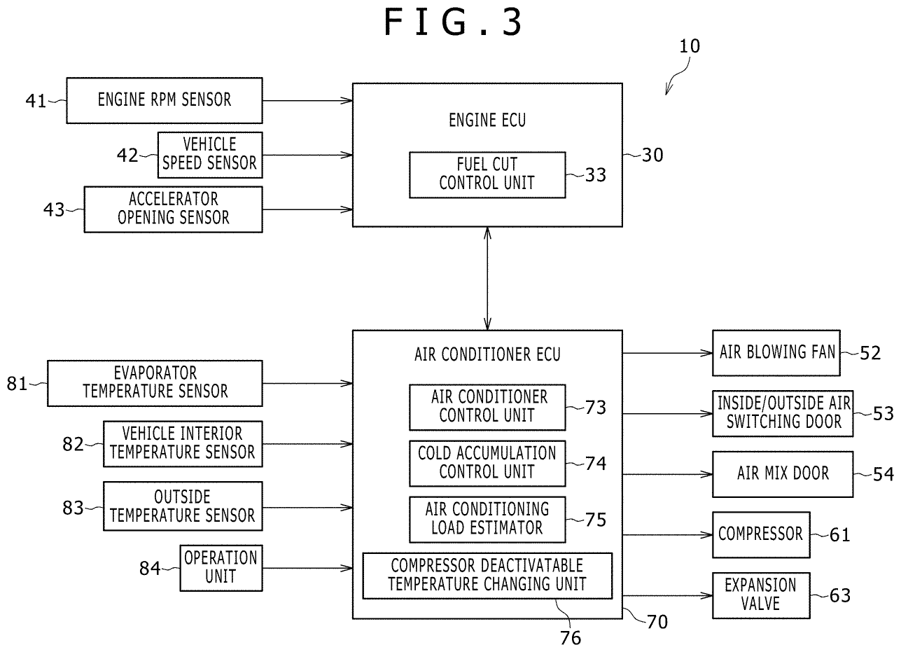

As shown in FIG. 3, the engine ECU 30 includes a fuel cut control unit 33 which performs the F/C control to stop fuel supply to the engine 20. The fuel cut control unit 33 is implemented by the processor 31 when the processor 31 executes the program stored in the memory 32.

The fuel cut control unit 33 starts the fuel cut control in response to a request for deceleration. Specifically, the fuel cut control unit 33 starts the fuel cut control when an accelerator opening is zero (i.e., the accelerator is released) and the vehicle speed matches or exceeds a third speed (of 40 km/h, for example). The fuel cut control unit 33 may start the fuel cut control when the accelerator opening is zero and an engine rpm matches or exceeds a third rpm (of 2000 rpm, for example).

A condition for the fuel cut control unit 33 to terminate the fuel cut control is that the vehicle speed matches or falls below a second speed (of 30 km/h, for example), or that the engine rpm matches or falls below a second rpm (of 1500 rpm, for example).

When the condition of terminating the F/C control is satisfied, however, in a case where the compressor 61 in the air conditioner 50 is deactivated, the fuel cut control unit 33 extends the fuel cut control until the vehicle speed matches or falls below a first speed (of 20 km/h, for example) which is lower than the second speed, or until the engine rpm matches or falls below a first rpm (of 1000 rpm, for example) that is lower than the second rpm. The reason for extending the fuel cut control will be explained below. During operation under the F/C control, an evaporator 64 is sufficiently cooled to accumulate the cold due to cold accumulation control performed by the air conditioner ECU 70, which will be described further below, and the compressor 61 is deactivated in a case where the temperature of the evaporator 64 matches or falls below a compressor deactivation permissible temperature when the condition for terminating the F/C control is satisfied. Because of this, there is no necessity for fuel to be supplied to the engine 20 in order to actuate the compressor 61, which can allow the F/C control to be extended, even though the engine rpm becomes lower than the second rpm, until the engine rpm is further decreased to the first rpm or lower.

It should be noted that values of the above-described engine rpm decrease in order from the third rpm, the second rpm, and the first rpm, while values of the vehicle speed decrease in order from the third speed, the second speed, and the first speed.

### Air Conditioner

As shown in FIG. 2, the air conditioner 50 includes the air passage 51 through which air is supplied into the vehicle interior 6, an air blowing fan 52 which generates an air flow directed into the vehicle interior 6, an inside/outside air switching door 53 which switches between feeding of air into the vehicle interior 6 (inside air) and feeding of air from outside the vehicle 5 (outside air), an air mix door 54 which switches between blowing of air into the heater core 22 and not blowing air into the heater core 22, and the refrigeration cycle circuit 60 which cools air flowing through the air passage 51.

The refrigeration cycle circuit 60 includes the compressor 61 which compresses a refrigerant, an outdoor heat exchanger 62 which condenses the refrigerant, an expansion valve 63 which expands the refrigerant, and the evaporator 64 disposed within the air passage 51. The compressor 61 is actuated by the engine 20. Further, the compressor 61 is of a variable capacity type, and has a capacity which can be increased or decreased by changing an angle of a swash plate 65.

Meanwhile, the air conditioner ECU 70 is connected to the clutch 23, the air blowing fan 52, the inside/outside air switching door 53, the air mix door 54, the compressor 61, and the expansion valve 63, and is configured to send thereto control signals for connecting or disconnecting between the engine 20 and the compressor 61, regulating an airflow volume supplied by the air blowing fan 52, adjusting an opening of the inside/outside air switching door 53, adjusting an opening of the air mix door 54, changing the capacity of the compressor 61, and adjusting an opening of the expansion valve 63. In addition, the air conditioner ECU 70 is also connected to the above-described engine ECU 30.

As shown in FIG. 3, the air conditioner ECU 70 includes control blocks of an air conditioner control unit 73, a cold accumulation control unit 74, an air conditioning load estimator 75, and a compressor deactivation permissible temperature changing unit 76, which will be respectively explained in detail below. The air conditioner control unit 73, the cold accumulation control unit 74, the air conditioning load estimator 75, and the compressor deactivation permissible temperature changing unit 76 are implemented by the processor 71 when the processor 71 executes the program stored in the memory 72.

The air conditioner control unit 73 controls components of the air conditioner 50 to establish a preset temperature in the vehicle interior 6. More specifically, the air conditioner control unit 73 calculates a target discharge temperature, a target airflow volume, a target inside/outside air switching door opening, and a target air mix door opening, based on an outside air temperature, an inside air temperature, and the present temperature. Further, the air conditioner control unit 73 regulates the airflow volume supplied by the air blowing fan 52, the opening of the inside/outside air switching door 53, the opening of the air mix door 54, activates or deactivates the compressor 61, adjusts the capacity of the compressor 61, and regulates the opening of the expansion valve 63, so as to attain the calculated target discharge temperature, the target airflow volume, and the target inside/outside air switching door opening and the target air mix door opening.

The cold accumulation control unit 74 operates the compressor 61 to cool the evaporator 64 for accumulating the cold (hereinafter referred to as cold accumulation control) during operation of the F/C control that is performed by the engine ECU 30. In this way, rotational driving energy from the engine 20 during operation of the F/C control can be utilized for cooling the evaporator 64 to accumulate the cold therein.

Further, the cold accumulation control unit 74 sets the capacity of the compressor 61 to the maximum capacity for allowing the compressor 61 to be operated at its maximum output during operation of the cold accumulation control. This can allow the air conditioner 50 to utilize most of the rotational driving energy from the engine 20 when F/C control is in progress.

Still further, the cold accumulation control unit 74 deactivates the compressor 61 in a case where the temperature of the evaporator 64 matches or falls below the compressor deactivation permissible temperature when the condition of terminating the F/C control is satisfied. On the other hand, when the temperature of the evaporator 64 is higher than the compressor deactivation permissible temperature, the cold accumulation control unit 74 maintains operation of the compressor 61, while the air conditioner controller 73 controls the components of the air conditioner 50 to maintain the vehicle interior 6 at the preset temperature.

The air conditioning load estimator 75 estimates an air conditioning load based on at least one of the outside air temperature, the target discharge temperature, the vehicle interior temperature, and the air discharge volume.

The compressor deactivation permissible temperature changing unit 76 sets a value that is greater than the predetermined value as the compressor deactivation permissible temperature when the estimated air conditioning load is low. This is because the vehicle interior 6 can be kept comfortable even though the compressor 61 is deactivated earlier with the cold accumulation control when the air conditioning load is low. For example, when the outside air temperature which is used as a basis for estimating the air conditioning load is low, the value that is higher than the predetermined value is set as the compressor deactivation permissible temperature. In this case, the compressor 61 will be deactivated even though the evaporator temperature is higher than the predetermined temperature when the condition of terminating the F/C control is satisfied, which can, in turn, increase occurrences where the F/C control is extended. As a result, the fuel efficiency of the vehicle 5 can be improved.

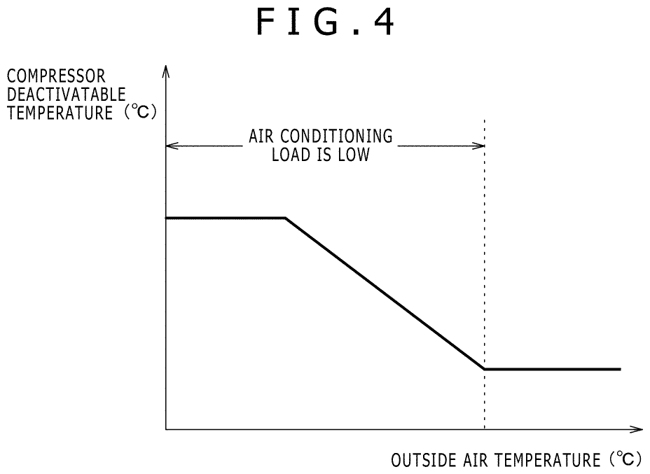

When the air conditioning load estimator 75 estimates the air conditioning load based on the outside air temperature, because the air conditioning load is low at outside air temperatures that match or fall below a predetermined outside air temperature as shown in FIG. 4, the compressor deactivation permissible temperature changing unit 76 raises the compressor deactivation permissible temperature as the outside air temperature decreases from the predetermined outside air temperature, in order to increase occurrences of situations where the compressor 61 is deactivated. It should be noted that also in a case where the air conditioning load estimator 75 estimates the air conditioning load based on the vehicle interior temperature or the airflow volume, the compressor deactivation permissible temperature changing unit 76 raises the compressor deactivation permissible temperature as the vehicle interior temperature or the airflow volume decreases, as in the case of the example shown in FIG. 4.

When the air conditioning load estimator 75 estimates the air conditioning load based on the target discharge temperature, the compressor deactivation permissible temperature changing unit 76 raises the compressor deactivation permissible temperature as the target discharge temperature is increased from a predetermined target discharge temperature.

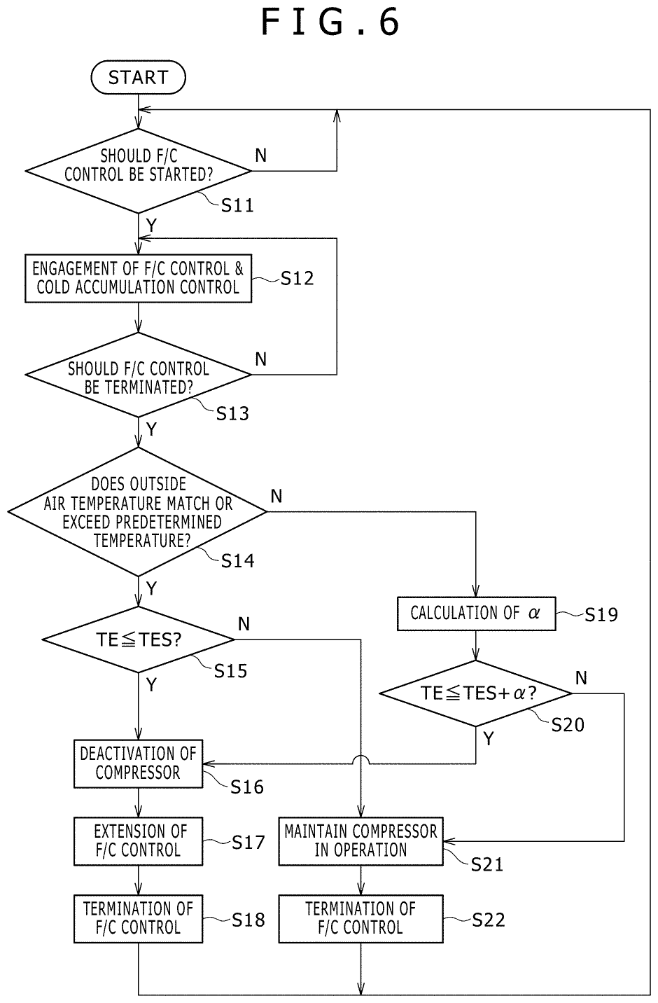

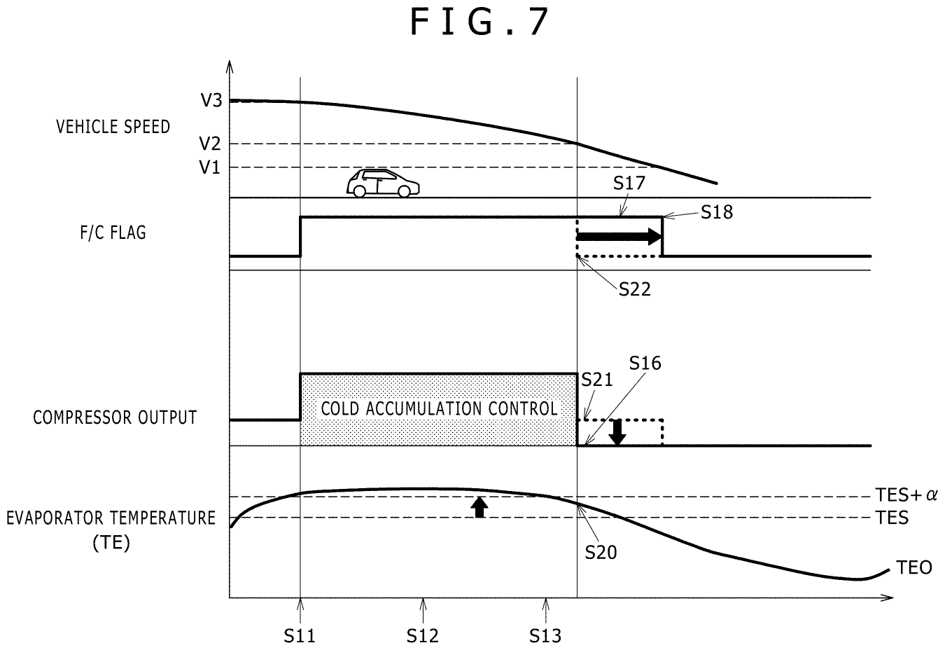

A flow of process steps performed by the Engine ECU 30 and the air conditioner ECU 70 will be explained with reference to FIGS. 6 and 7.

As shown in FIG. 6, when the vehicle speed is decreased to a third speed V3 or lower in response to a release of the accelerator, for example, the fuel cut control unit 33 in the engine ECU 30 determines, in step S11, that the F/C control should be started, and operation moves to step S12.

In step S12, the fuel cut control unit 33 performs the F/C control. Simultaneously with this, the cold accumulation control unit 74 in the air conditioner ECU 70 changes the angle of the swash plate 65 in the compressor 61 so as to maximize the capacity of the compressor 61, and operates the compressor 61 with its maximum output to cool the evaporator 64 for accumulating the cold therein.

In step S13, when the vehicle speed matches or falls below a second speed V2, the fuel cut control unit 33 determines that the condition of terminating the F/C control is satisfied and operation moves to step S14.

In step S14, the air conditioning load estimator 75 in the air conditioner ECU 70 determines whether or not the outside air temperature is lower than the predetermined temperature, in order to estimate the air conditioning load based on the outside air temperature, for example. When the outside air temperature is determined to match or exceed the predetermined temperature, operation moves to step S15. When the outside air temperature is determined to be lower than the predetermined temperature, operation jumps to step S19.

In step S15, the cold accumulation control unit 74 determines whether or not an evaporator temperature TE matches or falls below a compressor deactivation permissible temperature TES. When the evaporator temperature TE is determined to match or fall below the compressor deactivation permissible temperature TES, operation moves to step S16. When the evaporator temperature TE is determined to be higher than the compressor deactivation permissible temperature TES, operation jumps to step S21.

In step S16, the cold accumulation control unit 74 deactivates the compressor 61. In step S17, the fuel cut control unit 33 in the engine ECU 30 extends the F/C control. In step S18, when the vehicle speed is decreased to a first speed V1 or lower, the fuel cut control unit 33 terminates the F/C control.

When the air conditioning load is low, it is assumed that the vehicle interior 6 can be kept comfortable even after the compressor 61 is deactivated when the condition of terminating the F/C control is satisfied. Based on this assumption, in step S19, the compressor deactivation permissible temperature changing unit 76 in the air conditioner ECU 70 calculates, from the characteristics and the outside air temperatures shown in FIG. 4, an increment a to the compressor deactivation permissible temperature, and adds the calculated increment a to the predetermined value TES to raise the compressor deactivation permissible temperature.

In step S20, the cold accumulation control unit 74 determines whether or not the evaporator temperature TE matches or falls below the compressor deactivation permissible temperature (TES+α). When the evaporator temperature TE is determined to match or fall below the compressor deactivation permissible temperature (TES+α), operation moves to step S16. When the evaporator temperature TE is determined to be greater than the compressor deactivation permissible temperature (TES+α), operation moves to step S20.

In step S21, the cold accumulation control unit 74 maintains operation of the compressor 61. In step S22, the fuel cut control unit 33 in the engine ECU terminates the F/C control. Then, the air conditioner control unit 73 controls the components of the air conditioner 50 to establish the preset temperature of the vehicle interior 6.

As shown in FIG. 7, in a case where the outside air temperature used as the basis for estimating the air conditioning load, for example, is low, the compressor 61 has conventionally been operated when the F/C control is terminated (as indicated by broken lines in FIG. 7), whereas the compressor 61 is deactivated in the vehicle control system 10 according to this embodiment (as indicated by solid lines in FIG. 7). As a result, the occurrence of situations where the F/C control is extended can be increased, which can, in turn, improve the fuel efficiency of the vehicle 5.

The present disclosure is not limited to the above-described embodiment or modification examples thereof, and the components and features described herein may be changed or improved in various ways without departing from the scope of the accompanying claims.

1. A vehicle control system, comprising:
an engine controller configured to perform fuel cut control for stopping fuel supply to an engine; and
an air conditioner controller configured to control an air conditioner comprising a compressor which is driven by a rotational driving force of the engine, wherein
the engine controller is further configured to start the fuel cut control in response to a request for deceleration;
the air conditioner controller is further configured to operate the compressor for accumulating coldness during operation when the fuel cut control is being performed by the engine controller, and deactivate the compressor in a case where a temperature of an evaporator matches or falls below a predetermined value of a compressor deactivation permissible temperature when a condition for terminating the fuel cut control is satisfied;
the engine controller is further configured to extend the fuel cut control in a case where the compressor is deactivated when the condition of terminating the fuel cut control is satisfied; and
the air conditioner controller further comprises a compressor deactivation permissible temperature changing unit configured to set a value greater than the predetermined value as the compressor deactivation permissible temperature when an estimated air conditioning load is low.

2. The vehicle control system according to claim 1, wherein the air conditioner controller further comprises an air conditioning load estimator configured to estimate the air conditioning load based on at least one of an outside air temperature, a target discharge temperature, a vehicle interior temperature, and an air discharge volume.

3. The vehicle control system according to claim 1, wherein:
the compressor is of a variable capacity type;
the air conditioner controller is further configured to maximize a capacity of the compressor and operate the compressor with a maximum output thereof during operation when the fuel cut control is being performed by the engine controller.

4. The vehicle control system according to claim 2, wherein:
the compressor is of a variable capacity type;
the air conditioner controller is further configured to maximize a capacity of the compressor and operate the compressor a maximum output thereof during operation with the fuel cut control being performed by the engine controller.
